(19) United States
(12) Patent Application Publication
(10) Pub. No.: US 2014/0145813 A1
(43) Pub. Date: May 29, 2014

(54) PLANAR HIGH VOLTAGE TRANSFORMER

(71) Applicant: GE Medical Systems Global Technology Company, LLC, Waukesha, WI (US)

(72) Inventors: Jianhai Zhang, Beijing (CN); Wei Lin, Beijing (CN); Qiang Cheng, Beijing (CN)

(73) Assignee: GE Medical Systems Global Technology Company, LLC, Waukesha, WI (US)

(21) Appl. No.: 14/080,871

(22) Filed: Nov. 15, 2013

(30) Foreign Application Priority Data
Nov. 23, 2012 (CN) 201210483640.3

(51) Int. Cl. H01F 27/42

(52) U.S. Cl. CPC H01F 27/42
USPC 336/200

(57) ABSTRACT

A planar high voltage transformer comprising a magnetic core, a primary winding, a secondary winding, and an insulating plate is provided, wherein the secondary winding comprises a plurality of secondary winding printed circuit boards each having a secondary coil distributed thereon.

### FIELD OF INVENTION

Embodiments of the present invention relate to high voltage transformers, and more particularly, to a planar high voltage transformer.

### BACKGROUND TO THE INVENTION

Planar transformers are widely used due to their advantages of small volume and slight coil parameter variation. FIG. 1 shows a planar transformer for use in low voltage applications, comprising a coil 102 delineated on a printed circuit board (PCB) 103 and a magnetic core 101 mounted on a surface of the PCB.

The prior art also discloses some planar transformers for use in high voltage applications, namely, planar high voltage transformers. The US Patent Publication No. 2007/0290784 discloses a planar high voltage transforming device, as shown in FIG. 2, which comprises a primary winding 4, a secondary winding 6, and magnetic cores 8, 10. Coil layers of the secondary winding are wound with each other in a direction substantially parallel to the plane of the primary winding. The U.S. Pat. No. 5,835,367 discloses a distributed planar high voltage transformer, as shown in FIG. 3, comprising the following components: planar voltage transforming devices for generating an output voltage of the module based on a rate of change of the magnetic flux, induced by the system input voltage, including a first terminal of a first voltage and a second terminal of a second voltage lower than the first voltage, wherein the output voltage of the planar voltage transforming device is determined from a difference between the first voltage and the second voltage; a coupling device for electrically coupling the planar voltage transforming devices. In addition, the summation of the output voltages of the planar voltage transforming devices is equal to the system output voltage.

However, the prior art, including the above-mentioned US patent publications, fails to solve a problem of a large distributed capacitance of the secondary winding in the planar high voltage transformer.

### BRIEF DESCRIPTION OF THE INVENTION

Embodiments of the present invention provide a novel planar high-voltage transformer capable of reducing a distributed capacitance of a secondary winding while maintaining a relatively small volume of the transformer, thereby solving the problem of a large distributed capacitance of the secondary winding in the high-voltage transformers in the prior art.

According to a first aspect of the present invention, there is provided a planar high voltage transformer comprising a magnetic core, a primary winding, a secondary winding including a plurality of secondary winding printed circuit boards, each having a secondary coil distributed thereon, and an insulating plate.

In combination with the first aspect, according to a second aspect of the present invention, there is provided a planar high voltage transformer, wherein the primary winding is hollow and the magnetic core passes through the hollow part of the primary winding.

In combination with the first aspect, according to a third aspect of the present invention, there is provided a planar high voltage transformer, wherein each secondary winding printed circuit board has a plurality of protrusions on a periphery thereof, each protrusion having a hole therein, and the insulating plate comprises a plurality of protrusions on the periphery thereof, each protrusion having a hole therein, for securing the insulating plate and the secondary winding printed circuit boards.

In combination with the above first, second or third aspect, according to a fourth aspect of the present invention, there is provided a planar high voltage transformer, wherein the secondary winding printed circuit boards have an opening therein allowing the secondary winding printed circuit boards to be fitted over the periphery of the primary winding.

In combination with the above fourth aspect, according to a fifth aspect of the present invention, there is provided a planar high voltage transformer, wherein two ends of each secondary coil are respectively provided with a bonding pad.

In combination with the above fifth aspect, according to a sixth aspect of the present invention, there is provided a planar high voltage transformer, wherein two ends of each secondary coil are respectively provided with a bonding pad, the secondary winding printed circuit board is a two-layer circuit board with one of the bonding pads being arranged on each layer, and a connection line of the two bonding pads is perpendicular to the plane of the printed circuit board.

In combination with the above first, second, or third aspect, according to a seventh aspect of the present invention, there is provided a planar high voltage transformer, wherein the insulating plate comprises a plurality of printed circuit boards, each printed circuit board having an opening therein, allowing the printed circuit boards to be fitted over the periphery of the primary winding.

In combination with the above fourth aspect, according to an eighth aspect of the present invention, there is provided a planar high voltage transformer, wherein the insulating plate comprises a plurality of printed circuit boards, each printed circuit board having an opening in the middle thereof, allowing the printed circuit boards to be fitted over the periphery of the primary winding.

In combination with the above sixth aspect, according to a ninth aspect of the present invention, there is provided a planar high voltage transformer, wherein the insulating plate comprises a plurality of printed circuit boards, each printed circuit board having an opening in the middle thereof, allowing the printed circuit boards to be fitted over the periphery of the primary winding.

In combination with the above ninth aspect, according to a tenth aspect of the present invention, there is provided a planar high voltage transformer, wherein each insulating plate is provided with a via bonding pad.

In combination with the above eighth aspect, according to an eleventh aspect of the present invention, there is provided a planar high voltage transformer, wherein the plurality of insulating plates and the plurality of secondary winding printed circuit boards are all fitted over the periphery of the primary winding, with the secondary winding printed circuit board sandwiched between two adjacent insulating plates.

In combination with the above tenth aspect, according to a twelfth aspect of the present invention, there is provided a planar high voltage transformer, wherein the bonding pads for the two ends of each secondary coil are aligned with the respective via bonding pads, and the insulating plates and the secondary winding printed circuit boards are attached against each other to achieve an electrical communication between the bonding pads for the two ends of the secondary coil with neighboring via bonding pads.

As compared with the prior art, the planar high voltage transformer according to embodiments of the present invention has the following advantageous technical effects: it achieves a smaller distributed capacitance of the secondary winding while maintaining a relatively small volume of the high voltage transformer; the planar high voltage transformers manufactured according to embodiments of the present invention have relatively small variations in the parameter; and the connection between the secondary coils is achieved by contact of the bonding pads, thereby eliminating the need of extra wiring.

### BRIEF DESCRIPTION OF THE DRAWINGS

FIG. 1 is a schematic diagram showing a planar low voltage transformer in the prior art;

FIG. 2 is a schematic diagram showing a planar high voltage transformer in the prior art;

FIG. 3 is a schematic diagram showing another planar high voltage transformer in the prior art;

FIG. 4 is an general structural view of a planar high voltage transformer according to an embodiment of the present invention;

FIG. 5 shows a specific structure of the planar high voltage transformer according to an embodiment of the present invention;

FIG. 6 is a schematic diagram of a PCB plate on which a secondary coil of the planar high voltage transformer according to an embodiment of the present invention is distributed;

FIG. 7 is a schematic diagram of an insulating plate of the planar high voltage transformer according to an embodiment of the present invention; and

FIG. 8 is a schematic diagram showing the electrical connection between an insulating plate and neighboring secondary winding printed circuit boards of the planar high voltage transformer according to an embodiment of the present invention.

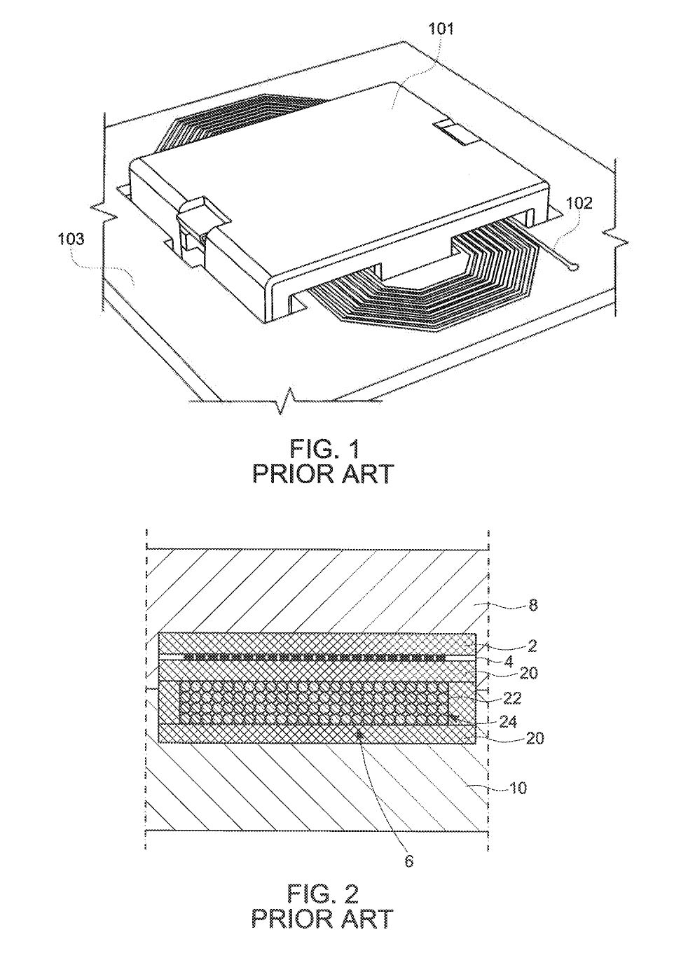

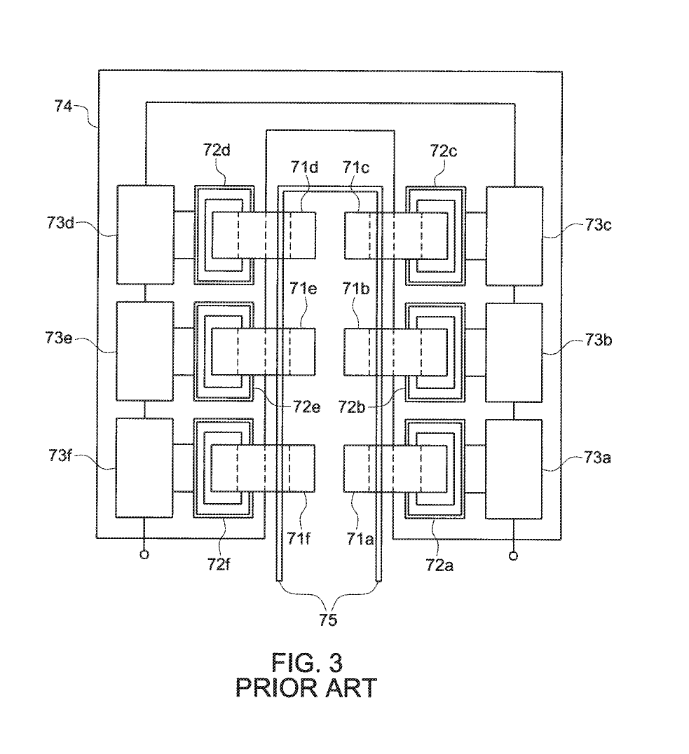

### DETAILED DESCRIPTION OF THE INVENTION

Embodiments of the present invention are further described with reference to the drawings and specific embodiments.

FIG. 4 shows a general structure of a planar high voltage transformer according to an embodiment of the present invention, which comprises a magnetic core 401, a primary winding 402, a plurality of insulating plates 403, and a plurality of secondary winding printed circuit boards 404. To facilitate manufacture and processing, the primary winding can be designed to be a hollow cylinder. Accordingly, the part of the magnetic core 401 that passes through the primary winding 402 is also designed to be a cylinder. Of course, the primary winding and the magnetic core can be in other geometries as well.

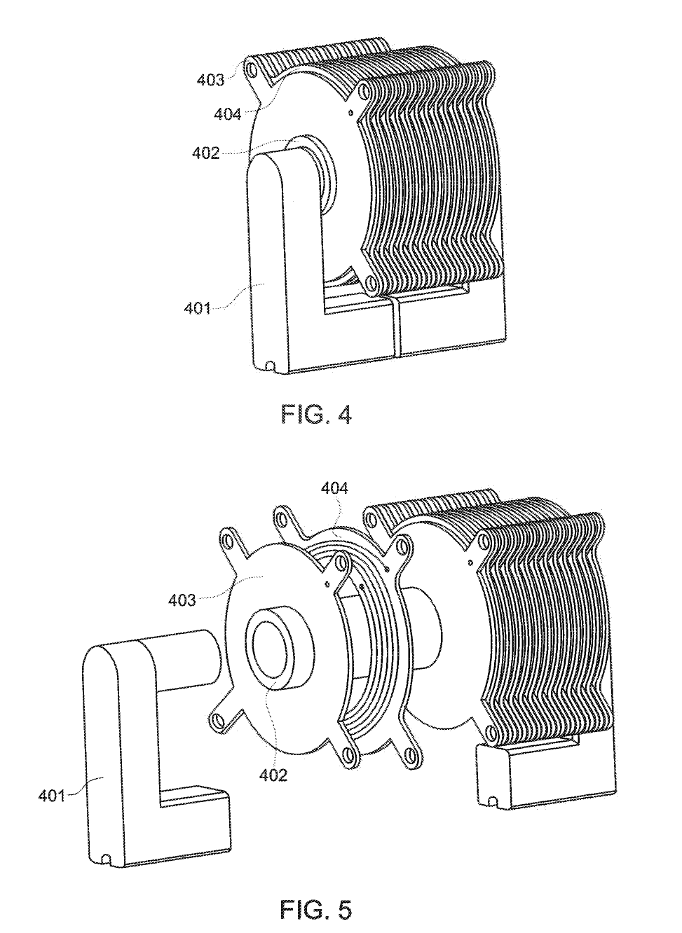

FIG. 5 shows a specific connection for various components in the planar high voltage transformer according to an embodiment of the present invention. The primary winding 402 is hollow. The magnetic core 401 passes through the hollow part of the primary winding 402. The plurality of insulating plates 403 and the plurality of secondary winding printed circuit boards 404 are all fitted over the periphery of the primary winding, and one secondary winding printed circuit board 404 is sandwiched between two adjacent insulating plates 403.

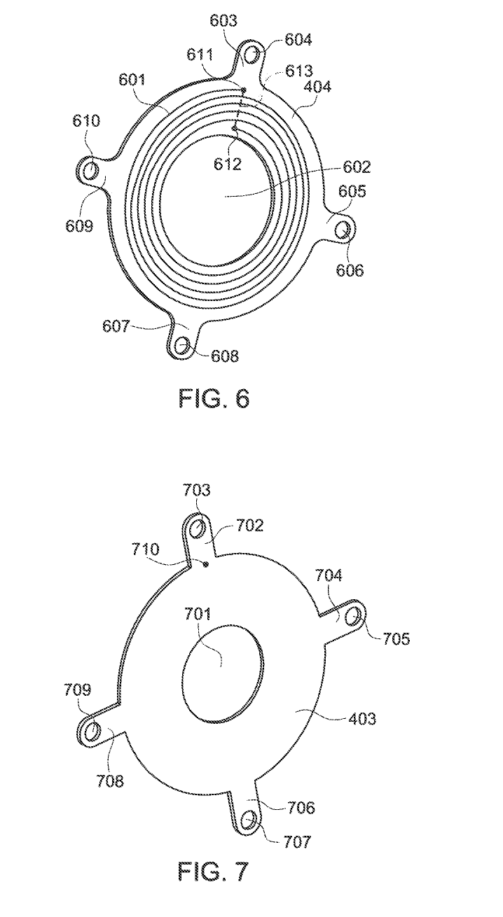

FIG. 6 shows a structure for a secondary winding printed circuit board. A secondary coil 601 is distributed on a secondary winding printed circuit board 404, which is a two-layer PCB board. An opening 602, centered by the central point of the coil, is provided in the secondary winding printed circuit board so that the secondary winding printed circuit board 404 can fit over the periphery of the primary winding 402.

The secondary winding printed circuit board 404 includes a plurality of protrusions 603, 605, 607, 609 at the periphery thereof. Each protrusion has a hole 604, 606, 608, 610 therein for securing the secondary winding printed circuit boards 404 with the insulating plates 403.

Each secondary coil is provided with bonding pads 611, 612 for the two ends respectively. The two bonding pads are respectively arranged on each layer of the two-layer printed circuit board ensuring a connection line of the two bonding pads is perpendicular to the plane of the printed circuit board. For example, the secondary coil 601 and the bonding pad 611 for one end of the secondary coil are provided on the visible, top layer of the PCB, the other end of the secondary coil is connected to the bottom layer (the back side, not visible) of the PCB through a hole 613, as shown in FIG. 6, and then connected to another bonding pad 612 on the bottom layer of the PCB through a wire 614 (indicated by the dotted line in FIG. 6) provided in the bottom layer of the PCB.

FIG. 7 shows a structure of an insulating plate. Each insulating plate 403 is also a printed circuit board and has an opening 701 therein so that the insulating plate can fit over the periphery of the primary winding 402. The insulating plate is provided with a plurality of protrusions 702, 704, 706, 708 at the periphery thereof, each protrusion having a hole 703, 705, 707, 709 therein for securing the insulating plates 403 with the secondary winding printed circuit boards 404.

Each insulating plate is provided with a via bonding pad 710.

To facilitate mounting and securing, each secondary winding printed circuit board 404 and the insulating plate 403 have a same size. The protrusions of each secondary winding printed circuit board and the protrusions of each insulating plate are arranged at same positions on respective printed circuit boards, and both secondary winding printed circuit board and the insulating plate are also same in positions of their holes in respective protrusions. Each secondary winding printed circuit board and the insulating plate have the opening 602 and the opening 701 respectively arranged in same positions thereon.

To facilitate electrical connections among the secondary winding printed circuit boards, positions of the via bonding pads 710 on the insulating plates are exactly the same as the positions, on the secondary winding printed circuit boards, of the bonding pads 611, 612 for the two ends of the coil on the secondary winding printed circuit boards.

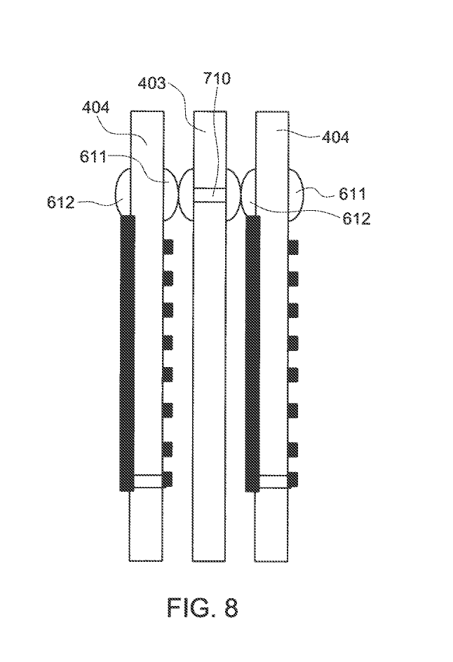

FIG. 8 shows a state after the insulating plates and the secondary winding printed circuit boards designed according to the above requirements are fitted over the primary winding 402 in an alternate manner. Two adjacent secondary winding printed circuit boards 404 and an insulating plate 403 sandwiched there between are shown for purpose of illustration. To achieve electrical connection between the secondary coils on the two secondary winding printed circuit boards, in fitting the three printed circuit boards, it is only required to make the two bonding pads 611, 612 on the two secondary winding printed circuit boards 404 facing the insulating plate 403 are aligned and contacted with the via bonding pad 710 on the insulating plate, and the three printed circuit boards are secured together by the securing holes 604, 606, 608, 610 and 703, 705, 707, 709 thereon. As such, a reliable electrical connection between the secondary coils on two adjacent secondary winding printed circuit boards is achieved. Using the same method, all secondary coils can be reliably electrically connected without the need of extra wiring.

The planar high voltage transformers manufactured according to embodiments of the present invention have relatively small parameter variations. The planar high voltage transformer according to embodiments of the present invention can achieve a smaller distributed capacitance of the secondary winding with a relatively small volume of the high voltage transformer.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural element with insubstantial differences from the literal languages of the claims.

What is claimed is:

1. A planar high voltage transformer comprising:
a magnetic core;
a primary winding;
a secondary winding comprising a plurality of secondary winding printed circuit boards, each of the secondary winding printed circuit boards comprising a secondary coil distributed thereon; and
an insulating plate.

2. The planar high voltage transformer according to claim 1, wherein the secondary winding printed circuit boards comprise an opening therein allowing the secondary winding printed circuit boards to be fitted over a periphery of the primary winding.

3. The planar high voltage transformer according to claim 1, wherein the primary winding comprises a hollow part, and the magnetic core passes through the hollow part of the primary winding.

4. The planar high voltage transformer according to claim 3, wherein the secondary winding printed circuit boards comprise an opening therein allowing the secondary winding printed circuit boards to be fitted over a periphery of the primary winding.

5. The planar high voltage transformer according to claim 1, wherein each of the secondary winding printed circuit boards comprises a plurality of protrusions on the periphery thereof, each of the protrusions comprising a hole therein, and the insulating plate comprises a plurality of protrusions on the periphery thereof, each of the protrusions comprising a hole, wherein the plurality of protrusions are configured to secure the insulating plate and the secondary winding printed circuit boards.

6. The planar high voltage transformer according to claim 5, wherein the secondary winding printed circuit boards comprise an opening therein, allowing the secondary winding printed circuit boards to be fitted over a periphery of the primary winding.

7. The planar high voltage transformer according to claim 6, wherein two ends of each of the secondary coil are respectively provided with a bonding pad.

8. The planar high voltage transformer according to claim 6, wherein each of the two ends of each of the secondary coil comprises a bonding pad, at least one of the secondary winding printed circuit boards is a two-layer circuit board with one of the bonding pads being arranged on each layer, and a connection line of the two bonding pads of the two ends is perpendicular to the plane of the at least one secondary winding printed circuit board.

9. The planar high voltage transformer according to claim 8, wherein the insulating plate further comprises a plurality of printed circuit boards, each of the printed circuit boards comprising an opening therein, allowing the printed circuit boards to be fitted over the periphery of the primary winding.

10. The planar high voltage transformer according to claim 9, wherein the insulating plate comprises a via bonding pad.

11. The planar high voltage transformer according to claim 10, wherein the bonding pads for the two ends of each of the secondary coil are aligned with the respective via bonding pads, and the insulating plate and the secondary winding printed circuit boards are attached against each other to achieve an electrical communication between the bonding pads for the two ends of each of the secondary coil with neighboring via bonding pads.

12. The planar high voltage transformer according to claim 6, wherein the insulating plate further comprises a plurality of printed circuit boards, each of the printed circuit boards comprising an opening therein, allowing the printed circuit boards to be fitted over the periphery of the primary winding.

13. The planar high voltage transformer according to claim 12, furthering comprising a plurality of insulating plates, wherein the printed circuit boards of the plurality of insulating plates and the plurality of secondary winding printed circuit boards are all fitted over the periphery of the primary winding, with one of the secondary winding printed circuit boards sandwiched between two adjacent insulating plates.

14. The planar high voltage transformer according to claim 1, wherein the insulating plate comprises a plurality of printed circuit boards, each of the printed circuit boards comprising an opening therein, allowing the printed circuit boards to be fitted over the periphery of the primary winding.
